(19) United States
(12) Patent Application Publication
(10) Pub. No.: US 2011/0259014 A1
(43) Pub. Date: Oct. 27, 2011

(54) REFINERY RESIDUALS PROCESSING FOR INTEGRATED POWER, WATER, AND CHEMICAL PRODUCTS

(75) Inventors: Gary Daniel Miller, Houston, TX (US); Benjamin Jason Crew, Spring, TX (US); Keith Alan White, Katy, TX (US); Evan Kent Dawson, Houston, TX (US)

(73) Assignee: General Electric Company, Schenectady, NY (US)

(21) Appl. No.: 12/766,839

(22) Filed: Apr. 23, 2010

(51) Int. Cl. F01K 23/10; F01K 7/16; F01K 13/00; F02C 7/22

(52) U.S. Cl. 60/772; 60/39.12; 60/670; 60/645

(57) ABSTRACT

Systems and methods are provided for processing refinery residuals. In one embodiment, the system may include a gasifier configured to produce syngas from refinery residuals. A gas turbine engine may produce power from the syngas, and the power may be provided to a desalination system. A portion of the syngas may be provided to a shift reactor.

### BACKGROUND OF THE INVENTION

The subject matter disclosed herein relates to a system and method for processing refinery residuals in a combined cycle power plant.

In general, integrated gasification combined cycle (IGCC) power plants are capable of generating energy from various hydrocarbon feedstock, such as coal, relatively cleanly and efficiently. IGCC technology may convert the hydrocarbon feedstock into a gas mixture of carbon monoxide (CO) and hydrogen (H₂), i.e., syngas, by reaction with oxygen and steam in a gasifier. These gases may be cleaned, processed, and utilized as fuel in a conventional combined cycle power plant.

Refinery residuals are residuals generated from various refinery processing units, such as distillation towers. The refinery residuals may not be sellable on the market and may have very little processing value. Typically, such refinery residuals are mixed with lighter feedstock and combusted in a boiler to generate steam that may be used in power plants, such as the combined cycle power plants mentioned above. However, the boiling of refinery residuals may generate relatively higher pollution, and the alternative uses of such refinery residuals are limited.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a refinery residuals processing system that includes a gasifier and a gas turbine engine. The gasifier produces syngas from refinery residuals and a moderator, and the gas turbine engine receives a first portion of the syngas and produces power. The system further includes a desalination system configured to receive the power produced by the gas turbine engine. Additionally, the system includes a shift reactor configured to receive a second portion of the syngas to produce a chemical output.

In a second embodiment, a system includes a refinery residuals processing system that includes a gasifier, a syngas cooler, and a steam turbine. The gasifier produces syngas from a slurry that includes coked refinery residuals and a fluid. The syngas cooler cools the syngas and produces steam, and the steam turbine receives the steam from the syngas cooler and produces power. The system further includes a desalination system that receives the power from the steam turbine.

In a third embodiment, a method includes receiving refinery residuals from a refinery residuals source, gasifying the refinery residuals to produce syngas, cooling the syngas to produce steam, generating power from the syngas, the steam, or both, using a gas turbine engine, and providing the power to a desalination system

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an embodiment of a simplified refinery residuals processing system;

FIG. 2 illustrates an embodiment of a refinery residuals processing system and that includes an integrated gasification combined cycle (IGCC) power plant system;

FIG. 3 illustrates an embodiment of a process for generating power, water and industrial chemical products from refinery residuals; and

FIG. 4 illustrates an embodiment of a solids processing system that includes an integrated gasification combined cycle (IGCC) power plant system in accordance with an embodiment of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Embodiments of the present invention include an integrated system for processing refinery residuals to produce power, freshwater, and industrial chemicals. The refinery residuals may be sourced from any suitable refinery processing units. The refinery residuals are provided to a gasifier to produce syngas, which is then treated, e.g., cleaned, and cooled. Steam generated during gasification of the refinery residuals and cooling of the syngas may be provided to a steam turbine for power generation. The cooled syngas may be provided to a gas turbine for additional power generation. Power generated by the steam turbine and/or the gas turbine may be provided to a desalination system to produce freshwater. Some of the syngas may be provided to a chemicals facility for use in producing industrial chemicals.

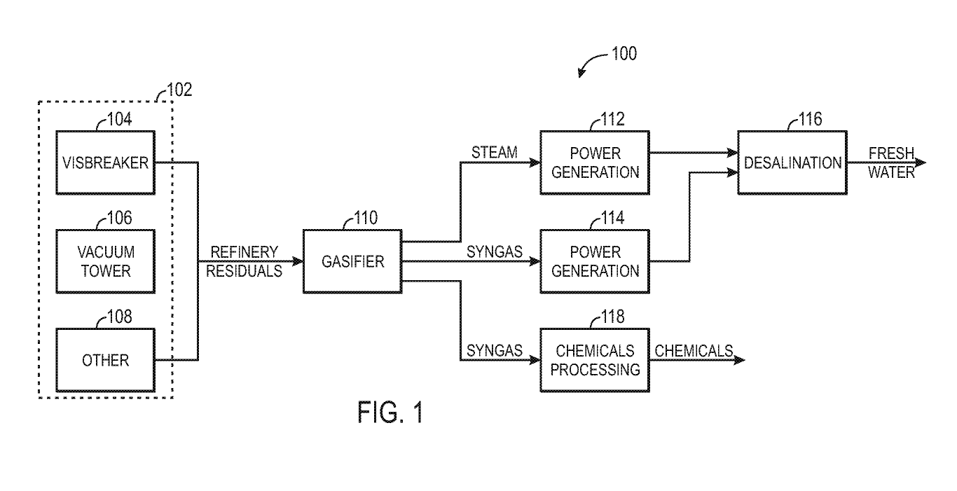

FIG. 1 illustrates a simplified refinery residuals processing system 100 in accordance with an embodiment of the present invention. Refinery residuals may be generated as waste produce (sometimes referred to as “bottoms”) from one or more refining processes and/or units 102. The refinery residues generally include any compounds that do not vaporize in processing units of a refinery. For example, refining processing units 102 that generate refinery residuals include a visbreaker 104, a vacuum tower 106, a distillation tower, and any other processing units 108. The refinery residuals include any low value feedstock, such as asphalt, tar, etc.

A heating value may be used to define energy characteristics of a fuel. For example, the heating value of a fuel may be defined as the amount of heat released by combusting a specified quantity of fuel. In particular, a lower heating value (LHV) may be defined as the amount of heat released by combusting a specified quantity (e.g., initially at 25° C. or another reference state) and returning the temperature of the combustion products to a target temperature (e.g., 150° C.). One example of LHV is Megajoules (MJ) per kilogram (kg). In the following discussion, LHV may be used to indicate the heating value of various fuels, but it is not intended to be limiting in any way. Any other value may be used to characterize the energy and/or heat output of feedstock within the scope of the disclosed embodiments. Keeping the foregoing discussion in mind, the refinery residuals include residuals having a lower heating value (LHV) of about 36 MJ/kg to about 40 MJ/kg, and may include residuals having an LHV of about 36, 37, 38, 39, or 40 MJ/kg. In other embodiments, the refinery residuals may include residuals having an LHV less than 40 MJ/kg, 39 MJ/kg, 38 MJ/kg, 37 MJ/kg, and 36 MJ/kg.

The refinery residuals may be provided to a gasifier 110 to produce syngas. As explained further below, the refinery residuals may be prepared before providing to the gasifier 110, and the syngas output of the gasifier 110 may be cooled, treated, and/or otherwise processed before further use. Additionally, the gasifier 110 and cooling of the syngas may produce steam, as discussed further below.

The outputs of the gasifier 110 may be used for power generation and/or industrial chemicals processing. For example, steam generated from the gasifier 110, syngas cooler, and/or other units in the system 100 may be provided to a power generation unit 112, such as a steam turbine engine. Some or all of the syngas may be provided to a power generation unit 114, such as a gas turbine engine. The power outputs of the power generation units 112 and 114 may be provided to a desalination system 116 that removes salt, or salt and other minerals, from saltwater to produce freshwater. In some embodiments, some or all of syngas may be provided to an industrial chemicals processing system 118 to produce industrial chemicals from the syngas and other inputs. Such industrial chemicals may include ammonia, methanol, or any other producible industrial chemical.

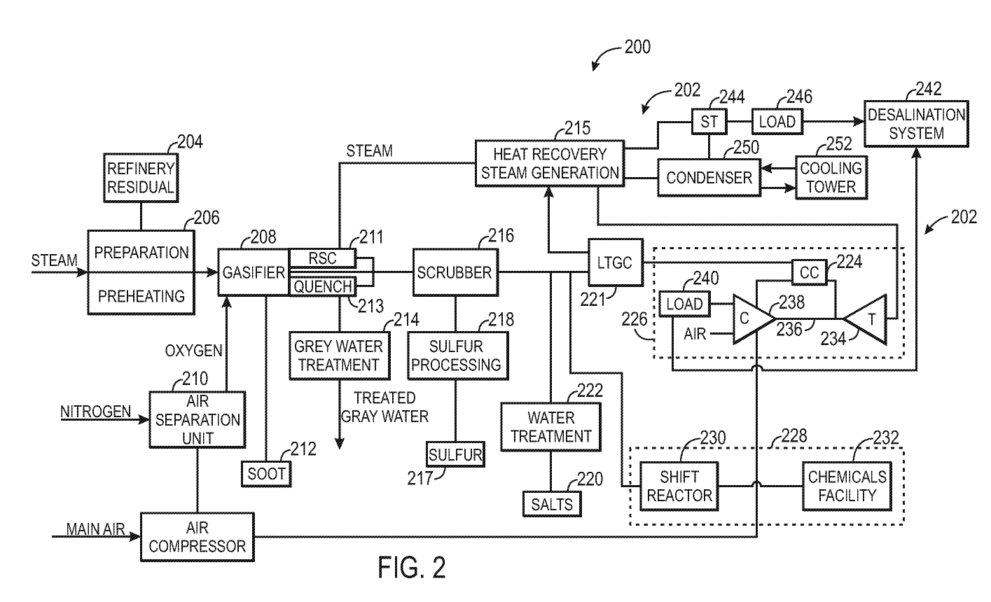

FIG. 2 illustrates a refinery residual processing system 200 that includes an integrated gasification combined cycle (IGCC) power plant system 202 in accordance with an embodiment of the present invention. The fuel source for the system 200 is refinery residuals 204 received from refinery processing systems and units. As described above, such refinery residuals may include residues of various distillation processes generally having a lower heating value of about 36 MJ/kg to about 40 MJ/kg, and may include residuals having an LHV of about 36, 37, 38, and 39 MJ/kg.

The refinery residuals 204 may be passed to a preparation/preheating unit 206 to be mixed a moderator, such as steam or other fluid. The steam may be used to atomize the refinery residuals feedstock, and the preparation/preheating unit 206 may include mixing apparatus to ensure adequate mixing of refinery residuals and the steam or other fluid.

In other embodiments, the moderator may include water, or other suitable liquids added to the refinery residuals 204 in the preparation unit 206 to create slurry feedstock. In some embodiments, the refinery residuals 204 may be used as feedstock without other non-refinery products as feedstocks. For example, the feedstock may consist of refinery residuals or slurry of refinery residuals and a fluid. The refinery residuals may also be preheated, such as in a heater of the unit 206.

After preparation, the refinery residuals feedstock may be provided to a gasifier 208. The gasifier 208 may convert the refinery residuals 204 into a combination of carbon monoxide and hydrogen, e.g., syngas. This conversion may be accomplished by subjecting the refinery residuals 204 to a controlled amount of high pressure oxygen, e.g., from approximately 20 to 85 bar, and temperatures, e.g., approximately 700 to 1600 degrees Celsius, depending on the type of gasifier utilized. The gasification process may also include the refinery residuals 204 undergoing a gasification process, e.g., pyrolysis and partial oxidation, whereby the refinery residuals 204 are heated. Temperatures inside the gasifier 208 of the gasification subsystem may range from approximately 1250-1450 degrees Celsius during the gasification process, depending on the composition of the refinery residuals 204. The heating of the feedstock during the gasification process may generate residual carbon, e.g. soot, and residue gases, e.g., carbon monoxide, hydrogen, and nitrogen. The soot remaining from the feedstock from the gasification process may only weigh up to approximately 1-2% of the weight of the original feedstock.

The oxygen may be supplied to the gasification subsystem from an air separation unit (ASU) 210. The ASU 210 may operate to separate air into component gases by, for example, distillation techniques that may be cryogenic or may utilize pressure swing adsorption (PSA). The ASU 210 may separate oxygen from the air supplied to it and may transfer the separated oxygen to the gasification subsystem. Additionally the ASU 210 may separate nitrogen, for example, for collection or for further use in power generation.

Accordingly, the oxygen is received by the gasification subsystem from the ASU 210 for oxidation purposes. The oxidation may include introducing oxygen to the residual carbon and residue gases so that the residue carbon and residue gases may react with the oxygen to form carbon dioxide and carbon monoxide, thus providing heat for the subsequent gasification reactions. The temperatures during the oxidation process may range from approximately 700 to 1600 degrees Celsius.

In this way, a resultant syngas is manufactured by the gasifier 208. This resultant gas may include approximately 85% of carbon monoxide and hydrogen, as well as CH₄, CO₂, H₂O, HCl, HF, COS, NH₃, HCN, and H₂S (based on the sulfur content of the feedstock). This resultant gas may be termed dirty syngas. The gasifier 208 may also generate waste, such as soot 212. This soot 212 may be removed from the gasifier 106, such as by combination with naphtha, and disposed of or recycled into the feedstock.

The gasifier 208 may include or may be coupled to a cooling unit, e.g., a radiant syngas cooler (RCS) 211, a quench unit 213, or a combination thereof. The radiant syngas cooler 211 may generate high pressure steam during the cooling process. Some or all of the steam may be provided to a heat recovery steam generator system (HRSG) 215, as described further below. In other embodiments, the cooling unit may include or may be the quench unit 213. Any blackwater generated from the quench unit 213 may treated (e.g., with naphtha) and removed as greywater and routed to a treatment unit 214 to remove ammonia and solids. If treated with naphtha, the naphtha rich stream may be reintroduced to the gasifier 208. Pretreated greywater may be reintroduced to the quench unit 213, the RSC 211, and/or feedstock preparation. The treated greywater may be routed to deepwell injection, biological treatment, or a zero process water discharge unit.

To cool and treat, e.g., clean, the dirty syngas, a gas cleaning unit, e.g., a scrubber 216, may be utilized. The scrubber 216 may include a venturi scrubber and/or packed column. The scrubber 216 may scrub the dirty syngas to remove the HCl, HF, COS, HCN, and H₂S from the dirty syngas, which may include separation of sulfur 217 in a sulfur processor 218 by for example, an acid gas removal process in the sulfur processor 218. Furthermore, the scrubber 216 may separate salts 220 from the dirty syngas via a water treatment unit 222 that may utilize water purification techniques to generate usable salts 220 from the dirty syngas. Scrubber water may be reintroduced to the quench unit 213 and/or the RSC 211. Subsequently, the gas from the scrubber 216 may include treated syngas. Some of the treated syngas may be provided to a low temperature gas cooling (LTGC) unit 221 that recovers heat and cools the syngas. Steam generated by the LTGC unit 221 may be provided to the HRSG 215, as described further below. The treated and cooled syngas may be routed to a combustor 224, e.g., a combustion chamber, of a gas turbine engine 226 as combustible fuel.

Some of the treated syngas may be provided to chemical processing system 228. The chemical processing system 228 may include a shift reactor 230. The shift reactor 230 may process the treated syngas to produce an appropriate ratio of carbon monoxide and hydrogen ratio for chemical production. After shift and heat recovery, the syngas may be routed to a chemicals facility 232, e.g., a methanol or ammonia converter.

As mentioned above, some or all of the treated syngas may be transmitted from the scrubber 216 to the combustor 224 of the gas turbine engine 226. The gas turbine engine 226 may include a turbine 234, a drive shaft 236 and a compressor 238, as well as the combustor 224. The combustor 224 may receive fuel, such as syngas, which may be injected under pressure from fuel nozzles. This fuel may be mixed with compressed air as well as compressed nitrogen and combusted within combustor 224. This combustion may create hot pressurized combustion gases.

The combustor 224 may direct the combustion gases towards an inlet of the turbine 234. As the combustion gases from the combustor 224 pass through the turbine 234, the combustion gases may force turbine blades in the turbine 234 to rotate the drive shaft 236 along an axis of the gas turbine engine 226. As illustrated, drive shaft 236 is connected to various components of the gas turbine engine 226, including the compressor 238.

The drive shaft 236 may connect the turbine 234 to the compressor 238 to form a rotor. The compressor 238 may include blades coupled to the drive shaft 236. Thus, rotation of turbine blades in the turbine 234 causes the drive shaft 236 connecting the turbine 234 to the compressor 238 to rotate blades within the compressor 238. This rotation of blades in the compressor 238 may cause the compressor 238 to compress air received via an air intake in the compressor 238. The compressed air may then be fed to the combustor 224 and mixed with fuel and compressed nitrogen to allow for higher efficiency combustion. Drive shaft 236 may also be connected to load 240, which may be a stationary load, such as an electrical generator for producing electrical power, for example, in a power plant. Indeed, load 240 may be any suitable device that is powered by the rotational output of the gas turbine engine 234. In one embodiment, the load 240 may be coupled to and power a desalination system 242. The desalination system 242 may process saltwater to remove salt and other dissolved solids and minerals from the saltwater using power provided by the turbine engine 226. The desalination system 242 may output freshwater for human consumption (e.g., drinking water), irrigation, and/or any other suitable purpose. Thus, the desalination system 242 is powered by syngas provided to the turbine engine 226 and generated from the refinery residuals 204.

The IGCC system 200 also may include a steam turbine engine 244 and the heat recovery steam generation (HRSG) system 215. The steam turbine engine 244 may drive a second load 246. The second load 246 may also be an electrical generator for generating electrical power. However, both the first and second loads 240 and 246 may be other types of loads capable of being driven by the gas turbine engine 226 and steam turbine engine 244. In addition, although the gas turbine engine 226 and steam turbine engine 244 may drive separate loads 240 and 246 as shown in the illustrated embodiment, the gas turbine engine 226 and steam turbine engine 244 may also be utilized in tandem to drive a single load via a single shaft. The specific configuration of the steam turbine engine 226, as well as the gas turbine engine 244, may be implementation-specific and may include any combination of sections. In one embodiment, the load 240 may provide power to the desalination system 242. As described above, the desalination system 242 may process saltwater and separate fresh water and salt from the saltwater using power provided by the steam engine 244.

In combined cycle systems such as IGCC system 200, hot exhaust may flow from the gas turbine engine 226 and pass to the HRSG 215, where it may be used to generate high-pressure, high-temperature steam. The steam produced by the HRSG 215 may then be passed through the steam turbine engine 244 for power generation. In addition, the produced steam may also be supplied to any other processes where steam may be used, such as to the preparation/preheating unit 206. The gas turbine engine 226 generation cycle is often referred to as the “topping cycle,” whereas the steam turbine engine 244 generation cycle is often referred to as the “bottoming cycle.” By combining these two cycles as illustrated in FIG. 2, the IGCC system 20 may lead to greater efficiencies in both cycles. In particular, exhaust heat from the topping cycle may be captured and used to generate steam for use in the bottoming cycle.

As described above, the HRSG 215 may receive steam from the RSC 211, from the LTGC 221, and/or from heated exhaust gas from the gas turbine engine 226. Any of these outputs may be routed to the HRSG 215 and used to heat water and produce steam used to power the steam turbine 244. Alternatively, in some embodiments, the HRSG 215 may be omitted and steam from the RSC 211, the LTGC 221, and/or the gas turbine engine 226 may be provided directly to the steam turbine 244. Exhaust from, for example, a low-pressure section of the steam turbine 244 may be directed into a condenser 250. The condenser 250 may utilize a cooling tower 252 to exchange heated water for chilled water. Cooling tower 252 acts to provide cool water to the condenser 250 to aid in condensing the steam transmitted to the condenser 250 from the steam turbine 244. Condensate from the condenser 250 may, in turn, be directed into the HRSG 215. Again, exhaust from the gas turbine engine 226 may also be directed into the HRSG 215 to heat the water from the condenser 250 and produce steam.

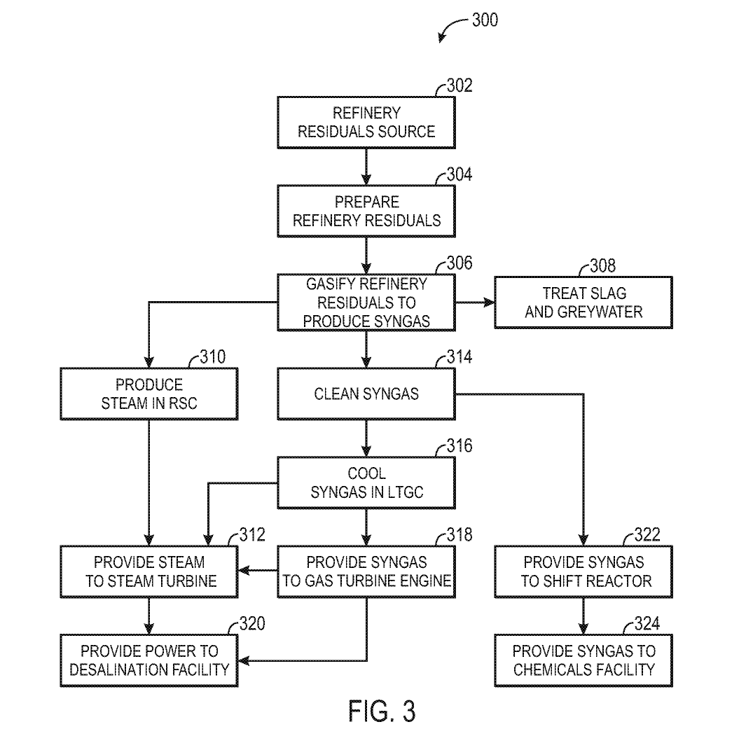

FIG. 3 depicts a process 300 for processing refinery residuals in accordance with an embodiment of the present invention. The process 300 illustrated in FIG. 3 and described below may be monitored and controlled by any suitable control scheme and devices. The process 300 may be monitored and controlled by any combination of hardware and software (e.g., code stored on a tangible computer-readable medium) components that communicate with control devices for the processing units described above in FIG. 2. In some embodiments, the process 300 may be implemented on one or more process controllers of a control system.

Initially, refinery residuals may be provided from a refinery residuals source (block 302), such as one or more units of a refinery. As described above, the refinery residuals include residuals having a lower heating value (LHV) of about 36 MJ/kg to about 40 MJ/kg, and may include residuals having an LHV of about 36, 37, 38, 39, or 40 MJ/kg. In other embodiments, the refinery residuals may include residuals having an LHV less than 40 MJ/kg, 39 MJ/kg, 38 MJ/kg, 37 MJ/kg, and 36 MJ/kg. Refinery residuals may be pumped as a liquid into the gasifier with possible addition of steam or water moderator. The refinery residuals may also be prepared for gasification (block 304), such as by coking them in a coker, grinding the residuals, and mixing with water to generate a coke slurry. The process 300 may then gasify the refinery residuals, such as in the gasifier 208, to produce syngas (block 306). Waste products from the gasification process, such as slag and gray water, may be treated (block 308), such as by removing ammonia and solids.

The gasification process may produce steam in an RSC (block 310). This steam may be provided to a steam turbine for power generation (block 312). Further processing of the syngas produced by gasification may include treating the syngas (block 314), such as by the scrubber, and cooling the syngas (block 316), such as in an LTGC section. Steam generated in the LTGC section may be provided to the steam turbine (block 312) for power generation.

The cooled syngas may be provided to a gas turbine engine for power generation (block 318). Steam generated by exhaust heat from the gas turbine may also be provided to the steam turbine for power generation (block 312). The power generated by the steam turbine (block 312) and the gas turbine engine (block 318) may be provided to a desalination facility (block 320) for producing freshwater.

In some embodiments, some or all of the syngas may be provided to a shift reactor (block 322). The shift reactor may produce a specific CO/H2 ratio in the syngas. The processed syngas from the shift reactor may be provided to a chemicals facility (block 324), e.g., a methanol or ammonia converter.

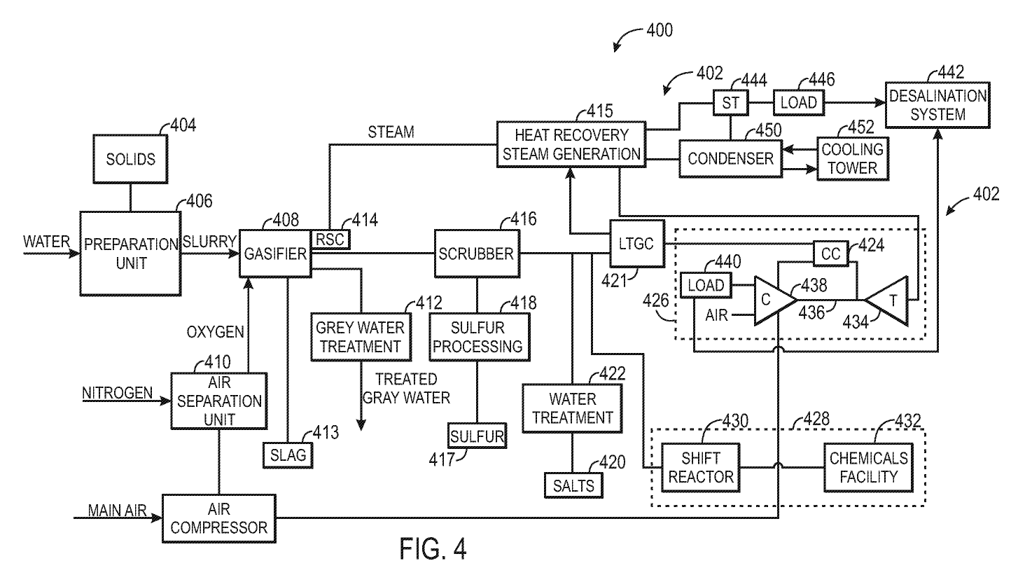

In other embodiments, the desalination system may be used with an IGCC system having solids (e.g., coal, petcoke, etc.) gasification. FIG. 4 illustrates a solids processing system 400 that includes an integrated gasification combined cycle (IGCC) power plant system 402 in accordance with an embodiment of the present invention. The fuel source for the system 400 may be solids 404 (e.g., coal, petcoke, etc.).

The solids 404 may be passed to a preparation unit 406. The preparation unit 406 may physically process the solids 404 by grinding, chopping, milling, shredding, pulverizing, briquetting, or palletizing the solids 404. Additionally, water, or other suitable liquids may be added to the solids 404 in the preparation unit 406 to create a slurry. In one embodiment, the solids 404 may be ground and mixed with water in the preparation unit 406 to generate a coke slurry.

After preparation, the slurry including the solids 404 may be passed to a gasifier 408. The gasifier 408 may convert the solids 404 into a combination of carbon monoxide and hydrogen, e.g., syngas. This conversion may be accomplished by subjecting the solids 404 to a controlled amount of steam and high pressure oxygen, e.g., from approximately 20 to 85 bar, and temperatures, e.g., approximately 700 to 1600 degrees Celsius, depending on the type of gasifier utilized. The gasification process may also include the solids 404 undergoing a pyrolysis process, whereby the solids 404 are heated. Temperatures inside the gasifier 408 of the gasification subsystem may range from approximately 150 to 700 degrees Celsius during the pyrolysis process, depending on the solids 404. The heating of the feedstock during the pyrolysis process may generate a solid, e.g., char, and residue gases, e.g., carbon monoxide, hydrogen, and nitrogen. The char remaining from the feedstock from the pyrolysis process may only weigh up to approximately 30% of the weight of the original feedstock.

A combustion process may then occur in the gasifier 408. To aid with this combustion process, oxygen may be supplied to the gasification subsystem from an air separation unit (ASU) 410. The ASU 410 may operate to separate air into component gases by, for example, distillation techniques that may be cryogenic or may utilize pressure swing adsorption (PSA). The ASU 410 may separate oxygen from the air supplied to it and may transfer the separated oxygen to the gasification subsystem. Additionally the ASU 410 may separate nitrogen, for example, for collection or for further use in power generation.

The combustion may include introducing oxygen to the char and residue gases so that the char and residue gases may react with the oxygen to form carbon dioxide and carbon monoxide, thus providing heat for the subsequent gasification reactions. The temperatures during the combustion process may range from approximately 700 to 1600 degrees Celsius. In some embodiments, steam may be introduced into the gasification subsystem during a gasification step. The char may react with the carbon dioxide and steam to produce carbon monoxide and hydrogen at temperatures ranging from approximately 800 to 1100 degrees Celsius.

The resultant syngas may include approximately 85% of carbon monoxide and hydrogen, as well as CH₄, CO₂, H₂O, HCl, HF, COS, NH₃, HCN, and H₂S (based on the sulfur content of the feedstock). This resultant gas may be termed dirty syngas. The gasifier 408 may also generate waste, such as slag 413, which may be a wet ash material. This slag 413 may be removed from the gasifier 408, such as through one or more lockhoppers, and disposed of, for example, as road base or as another building material. Greywater from the gasifier 408 may be routed to a treatment unit 412 to remove ammonia and solids. The treated greywater may be routed to deepwell injection, biological treatment, or a zero process water discharge unit. A portion of the treated greywater may be reintroduced to the scrubber 416.

The gasifier 408 may include or may be coupled to a cooling unit, e.g., a radiant syngas cooler (RSC) 414, that generates high pressure steam during the gasification process. Some or all of the steam may be provided to a heat recovery steam generator system (HRSG) 415, as described further below.

To cool and treat, e.g., clean, the dirty syngas, a gas cleaning unit, e.g., a scrubber 416, may be utilized. The scrubber 416 may include a venturi scrubber and/or packed column. The scrubber 416 may scrub the dirty syngas to remove the HCl, HF, COS, HCN, and H₂S from the dirty syngas, which may include separation of sulfur 417 in a sulfur processor 418 by for example, an acid gas removal process in the sulfur processor 418. Furthermore, the scrubber 416 may separate salts 420 from the dirty syngas via a water treatment unit 422 that may utilize water purification techniques to generate usable salts 420 from the dirty syngas. Scrubber water may be reintroduced to the quench unit 213 and/or the RSC 211 Subsequently, the gas from the scrubber 416 may include treated syngas. Some of the treated syngas may be provided to a low temperature gas cooling (LTGC) unit 421 that recovers heat and cools the syngas. Steam generated by the LTGC unit 421 may be provided to the HRSG 415, as described further below. The treated and cooled syngas may be routed to a combustor 424, e.g., a combustion chamber, of a gas turbine engine 426 as combustible fuel.

As described above, some of the treated syngas may be provided to chemical processing system 428. The chemical processing system 428 may include a shift reactor 430. The shift reactor 430 may process the treated syngas to produce an appropriate ratio of carbon monoxide and hydrogen ration for chemical production. After shift and heat recovery, the syngas may be routed to a chemicals facility 432, e.g., a methanol or ammonia converter.

As also mentioned above, some or all of the treated syngas may be transmitted from the scrubber 416 to the combustor 424 of the gas turbine engine 426. The gas turbine engine 426 may include a turbine 434, a drive shaft 436 and a compressor 438, as well as the combustor 424. As described above, the combustor 424 may receive fuel, such as syngas, which may be injected under pressure from fuel nozzles. This fuel may be mixed with compressed air as well as compressed nitrogen and combusted within combustor 424, to create hot pressurized combustion gases.

As described above, the combustion gases from the combustor 424 pass through the turbine 434 and may force turbine blades in the turbine 434 to rotate the drive shaft 436 along an axis of the gas turbine engine 426. As illustrated, drive shaft 436 is connected to various components of the gas turbine engine 426, including the compressor 438.

The drive shaft 436 may connect the turbine 434 to the compressor 438 to form a rotor. The compressor 438 may include blades coupled to the drive shaft 436. Thus, rotation of turbine blades in the turbine 434 causes the drive shaft 436 connecting the turbine 434 to the compressor 438 to rotate blades within the compressor 438. This rotation of blades in the compressor 438 may cause the compressor 438 to compress air received via an air intake in the compressor 438. The compressed air may then be fed to the combustor 424 and mixed with fuel and compressed nitrogen to allow for higher efficiency combustion. Drive shaft 436 may also be connected to load 440, which may be a stationary load, such as an electrical generator for producing electrical power, for example, in a power plant. Indeed, load 440 may be any suitable device that is powered by the rotational output of the gas turbine engine 434. In one embodiment of the system 400, the load 420 may be coupled to and power a desalination system 442. The desalination system 442 may process saltwater to remove salt and other dissolved solids and minerals from the saltwater using power provided by the turbine engine 426. The desalination system 442 may output freshwater for human consumption (e.g., drinking water), irrigation, and/or any other suitable purpose. Thus, the desalination system 442 is powered by syngas provided to the turbine engine 426 and generated from the solids 404.

The IGCC system 402 also may include a steam turbine engine 444 and the heat recovery steam generation (HRSG) system 415. The steam turbine engine 444 may drive a second load 446. The second load 446 may also be an electrical generator for generating electrical power. However, both the first and second loads 440 and 446 may be other types of loads capable of being driven by the gas turbine engine 426 and steam turbine engine 444. In addition, although the gas turbine engine 426 and steam turbine engine 444 may drive separate loads 440 and 446 as shown in the illustrated embodiment, the gas turbine engine 426 and steam turbine engine 444 may also be utilized in tandem to drive a single load via a single shaft. Again, the specific configuration of the steam turbine engine 426, as well as the gas turbine engine 444, may be implementation-specific and may include any combination of sections. In one embodiment, the load 440 may provide power to a desalination system 448. As described above, the desalination system 442 may process saltwater and separate fresh water and salt from the saltwater using power provided by the steam engine 444.

In combined cycle systems such as IGCC system 402, hot exhaust may flow from the gas turbine engine 426 and pass to the HRSG 415, where it may be used to generate high-pressure, high-temperature steam. The steam produced by the HRSG 415 may then be passed through the steam turbine engine 444 for power generation. In addition, the produced steam may also be supplied to any other processes where steam may be used, such as to the gasifier 408.

As described above, the HRSG 415 may receive steam from the RSC 414, from the LTGC 421, and/or from heated exhaust gas from the gas turbine engine 426. Any of these outputs may be routed to the HRSG 415 and used to heat water and produce steam used to power the steam turbine engine 426. Alternatively, in some embodiments, the HRSG 415 may be omitted and steam from the RSC 414, the LTGC 421, and/or the gas turbine engine 426 may be provided directly to the steam turbine 424. Exhaust from, for example, a low-pressure section of the steam turbine engine 426 may be directed into a condenser 450. The condenser 450 may utilize a cooling tower 452 to exchange heated water for chilled water. Cooling tower 452 acts to provide cool water to the condenser 450 to aid in condensing the steam transmitted to the condenser 450 from the steam turbine engine 444. Condensate from the condenser 450 may, in turn, be directed into the HRSG 415. Again, exhaust from the gas turbine engine 426 may also be directed into the HRSG 415 to heat the water from the condenser 450 and produce steam.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a refinery residuals processing system, comprising:
a gasifier adapted to produce syngas from refinery residuals and a moderator; and
a gas turbine engine configured to receive a first portion of the syngas and produce power;
a desalination system configured to receive the power produced by the gas turbine engine; and
a shift reactor configured to receive a second portion of the syngas to produce a chemical output.

2. The system of claim 1, comprising at least one of a methanol or ammonia converter configured to receive the chemical output of the shift reactor.

3. The system of claim 1, wherein the gasifier feed comprises the refinery residuals and moderator.

4. The system of claim 1, wherein a refinery residuals processing system comprises a refinery residuals preparation unit configured to receive the refinery residuals from one or more refinery processing units.

5. The system of claim 1, wherein the refinery residuals processing system comprises a scrubber configured to treat the syngas.

6. The system of claim 1, wherein the refinery residuals processing system comprises a greywater treatment unit configured to treat greywater from the gasifier.

7. The system of claim 1, wherein the refinery residuals processing system comprises a radiant syngas cooler configured to cool the syngas and produce steam.

8. The system of claim 1, wherein the refinery residuals processing system comprises a low temperature gas cooling unit configured to cool the syngas and produce steam.

9. The system of claim 1, comprising a heat recovery steam generation (HRSG) unit configured to produce steam at least partially with heat from exhaust output by the gas turbine engine.

10. The system of claim 1, wherein the refinery residuals have a lower heating value (LHV) of less than or equal to about 40 MJ/kg.

11. A system, comprising:
a refinery residuals processing system, comprising:
a gasifier adapted to produce syngas from a slurry consisting of coked refinery residuals and a fluid;
a syngas cooler configured to cool the syngas and produce steam; and
a steam turbine configured to receive the steam from the syngas cooler and produce power; and
a desalination system configured to receive the power produced by the steam turbine.

12. The system of claim 11, wherein the syngas cooler comprise a radiant syngas cooler coupled to the gasifier.

13. The system of claim 11, wherein the refinery residuals processing system comprises a gas cleaning unit configured to treat the syngas.

14. The system of claim 13, wherein the syngas cooler comprises a low temperature gas cooling unit configured to receive treated syngas from the gas cleaning unit and produce steam.

15. The system of claim 11, comprising a gas turbine engine configured to combust at least a portion of the syngas to produce power, and a heat recovery steam generation (HRSG) unit configured to produce steam at least partially with heat from exhaust output by the gas turbine engine.

16. The system of claim 15, wherein the desalination system is configured to receive power from the gas turbine engine.

17. The system of claim 11, wherein the precoked refinery residuals have a lower heating value of less than or equal to approximately 40 MJ/kg.

18. A method, comprising:
receiving refinery residuals from a refinery residuals source;
gasifying the refinery residuals to produce syngas;
cooling the syngas to produce steam;
generating power from the syngas, the steam, or both, with a turbine engine; and
providing the power to a desalination system.

19. The method of claim 18, wherein generating power comprises combusting a gas turbine engine to drive a first electrical generator, flowing the steam through a steam turbine to drive a second electrical generator, and providing the power comprises delivering electricity from the first and second electrical generators to the desalination system.

20. The method of claim 19, comprises providing a portion of refinery residuals to a chemical production system.
